(19) United States
(12) Patent Application Publication
(10) Pub. No.: US 2013/0081535 A1
(43) Pub. Date: Apr. 4, 2013

(54) PISTON-CHAMBER HYDRO-GRAVITY ENGINE

(71) Applicant: Stefanos Ntoukolianos, Thessaloniki (GR)

(72) Inventor: Stefanos Ntoukolianos, Thessaloniki (GR)

(21) Appl. No.: 13/261,475

(22) PCT Filed: Mar. 30, 2010
(86) PCT No.: PCT/GR2010/000015

§ 371 Date: Oct. 15, 2012

(30) Foreign Application Priority Data
Apr. 14, 2009 (GR) 20090100228

(51) Int. Cl. F03C 1/00

(52) U.S. Cl. CPC F03C 1/002
USPC 91/418; 91/471

(57) ABSTRACT

A piston-chamber hydro-gravity engine capable of converting the stagnant volume of the liquid matter of sea, lake, pond or artificially made hydro container, to a moving volume of liquid matter that flows back upon itself and in meanwhile exploits this motion as a working agent to produce mechanical kinetic power, capable of being used for mechanical production of kinetic work for hydro-electricity generation, or to be used multi-purposely for other energy needs that demand mechanical kinetic force sufficient to solve energy production problems worldwide forever beneficial to the economy and, friendly to the environment, consisting of particular accessories of mechanisms embodied in a single system of mutual successive co-operation by exploiting gravity, that is the hydro-container (7), capable of creating the means of exploiting the gravity-hydro-static tension of squashing compression exist within the volume of liquid matter of the sea, lake, pond or artificially made containers, the cylinder-chamber (15) and piston-chamber (1) these convert the stagnant gravity-hydro-static tension of force into a fluctuating homo-acting and counter-acting to gravity hydro-gravity-moving-force of action, that compels the piston-chamber (1) to reciprocate, the hermetically sealed vessel crank-cam-shaft chamber (8) operating as a participator in creating the means of the system piston-chamber hydro-gravity engine's function and meanwhile participating in the embodiment system that converts the reciprocating motion of piston-chamber (1), to a rotating motion capable of being used multi-purposely, where for the piston-chamber hydro-gravity engine to function it is necessary for the hydro-gravity force of action of conduits (19) to be less than the hydro-gravity force of action of piston-chamber (1), the area where conduits (19) adjusted hermetically fixed at the trunk of the cylinder-chamber (15) to be under the B.D.C. of piston-chamber (1 Reciprocating motion, the diameter of crank (11) to be approximately smaller than the distance of one period reciprocating motion of piston-chamber (1) which is between the T.D.C. and the B.D.C, the disc-valve (2) and the disc-valve (17) to close and open simultaneously when the piston-chamber is at the T.D.C and the B.D.C. of each period of its reciprocating motion within the gravity-hydrostatic tension of squashing compression through the inside area of cylinger-chamber (15).

### TECHNICAL FIELD OF THE INVENTION

The present invention relates to a method for engineering the technological system that produce mechanical kinetic work of small and large capacity for multipurpose use with the characteristic etymology piston-chamber hydro-gravity engine, where its piston-chamber (instead of a piston of a conventional piston-motor) exploits gravity by converting it to hydro-gravity and use the later as its functioning working agent, in particular as gravity applies force of action upon liquids with which naturally unites to a combination of hydro-gravity force of action and, the static resistance of the solid walls of naturally made basins or artificially made containers where liquid matter is confined in, convert this combination of hydro-gravity force of action into a combination of stagnant gravity-hydrostatic of outwards and inwards liquid's tension of squashing compressing resultant of force, that is consisting of three opposite applied forces, which as mentioned are gravity, the liquid matter and, the static resistance of solid matter from which are made the walls of natural basins or artificially made containers. Actually the present invention relates to a novel method consisting the technological engineering of an embodiment system, comprising of particular mechanical accessories with their moving and immobile parts, alternately cooperating together (as a piston-engine work) in a reciprocal mechanical order named piston-chamber hydro-gravity engine, meaning chambers look approximately like pistons and are capable in reciprocal steps to activate and use the stagnant bulk liquid matter for producing mechanical kinetic work of small and large capacity, with the characteristic etymology piston-chamber hydro-gravity engine, by exploiting the zeroed resultant of “gravity-hydro-static” inwards and outwards squashing compression of stagnant liquids confined into sea, lake, pond, or artificially made container and convert it to a moving hydro-gravity, working homo-actively and counter-actively for and against gravity, which in turn makes the liquid matter of sea, lake, pond, or artificially made hydro-container to continuously flowing back upon itself and, as it is remaining in its former place to make a piston-chamber of the technological system of piston-chamber hydro-gravity engine to move inwards and outwards within the gravity-hydro-static stagnant compression, through a cylinder-chamber capable to create simultaneously an inexhaustible source of renewable energy and mechanical kinetic force of small and large capacity, capable to satisfy multi-purposely the need of work demanding the power of engines, with the most economical way that ever existed before. The piston-chamber hydro-gravity engine is able to work autonomously from indigenous inexhaustible sources of energy everywhere in the world and the expense of its construction is the most costless. Also the material it uses as its working agent is the most abundant and free, as the piston-chamber hydro-gravity engine does not consume any physical or non physical materials to work, do not produce pollution or wastes to contaminate or harm the environment, or does not bereave earth of its physically working ordinances. Literally the present invention of the method consisting the technological engineering system of piston-chamber hydro-gravity engine, works as a mechanical imitation of living organization which can be single-piston-chamber or multi-piston-chambered hydro-gravity engine as usually most of piston motors are.

### RELEVANT PRIOR ART AND ASSESSMENT OF ITS PROBLEMS

Evidently according to scientific data, the contemporary existing art of energy production technology, convert hydropower to hydroelectric power or other forms of mechanical work by exploiting the naturally moving Hydropower, where this said practice brings experts in the field to conclude that the naturally moving hydropower until 2050 will not be capable to generate even approximately 20% percent (generously) of the total energy production of worldwide demand.

Plausibly, so far, as the contemporary technology of hydroelectricity production is confined to naturally moving water, inevitably the hydroelectric power plants are located in remote areas where naturally moving waters exist. There for, inevitably, as it is well known, technology to transmit electricity over long distances is required to build long distance power lines to the cities and other areas where energy has to be consumed and that makes it very expensive indeed, more to it, the environmental problems are created as hydroelectric dams of rivers disrupt the surrounding eco-system both upstream and downstream of the plant site where evidently reduce fish populations by preventing fish access to their spawning grounds. In addition, among other negative disadvantages the construction of hydroelectric dams, force the relocation of people living in areas where the reservoirs are planned.

According to statistics of February 2008 it was estimated that almost 80 million people worldwide had been displaced.

As a direct result of this practice of dam constructions, historically important sites with ancestral cultural attachments to places, which they have spiritual value to the displaced population are flooded and lost forever.

Failures of large dams can cause the death of hundreds and thousands of people and leave millions homeless as well, as dams are also subject to energy bombardment during wartime, terrorism and sabotage.

The construction of dams in geologically inappropriate location may cause disasters in case of an earthquake also.

Diminished river flow creates power shortages in areas that depend heavily on hydroelectric power, as hydroelectric generators depend on rainfall in the watershed, which is significantly reduced in low rainfall years.

Evidently, though renewable energy plays an important role, energy yield from ocean surface waves and tidal energy is not able to meet energy's demand, as numerous of technical problems affect progress in this direction, thus harnessing the harvest from sea and lake hydropower is very limited.

Almost the existing technological methods, exploiting renewable or non-renewable sources, evidently affect and change the environment, work against earth's natural ordinances of function, foundation and earth's inhabitants, at the expense of worldwide safety and living standards.

For the last thirty to forty years, or ever since “The Economics of Choice Between Energy Sources”, edited by Pierre Millet, Douglas Hague and Chris Rowland for the International Economic Association, experts in the field of renewable sources, despite their considerable efforts have not come up with one single alternative to conventional non renewable source of energy.

Only a negligible amount of commercial and industrial progress has been achieved so far in the production of energy by exploiting renewable sources and, the world is still to rely on non-renewable fuels which are very limited and will not last for long to service the majority of energy needs,

Because of this, our geo-solar-centered star system will continue to plunge deeper and deeper into a real predicament, unfortunately as the existing state of art for to generate energy continuous to depend on the consumption of the valuable natural hydrocarbons of liquids, gas, or solid natural material formation by changing the matter from which they are constructed and are used as working agents to activate various oil, steam, nuclear or other type of engines, cosmo-logically this practice is an abuse to the planet we live upon. We should make it sure the nature of cosmogony will pay it back in a way that is beyond human imagination.

By long survey and conclusions of historical data nesting in the long past times, it came up that an emission of micro-fragments of micro-tiny particles are produced by the friction of the hydrocarbon particles' axial rotation, as they approximately collide with the particles of solar and universe winds as soon as the latter reach the biosphere and produce gravity=barytes, that photosynthesize the first plasma of living mater, as each approximate coalition of micro-tiny particles is an epicenter of gravity formation.

The inventor of the present invention of the piston-chamber hydro-gravity engine which use as working agent the tension of gravity-hydro-static squashing compression of stagnant bulky liquid matter concludes that the earth orbits the sun in a perfect circle but an elliptical one according to the background of stars. As Earth orbits around the sun at the same time sway and swing from left to right and right to left from sun's pole to sun's pole parallel to the sun's curvature confirming that our star is solar centered indeed bat the earth orbits the sun in a perfect circle and not an elliptical one, thou to the back ground of stars it looks like an elliptical one.

However, as it is an indisputable fact that our star is solar centric, it is an indisputable fact that as all planets of our star system including the sun contribute for life to be created exclusively on earth, it is easy to assume that our solar system is geocentric also. Rightfully, we can call our star a solar-geo-centric star as well.

Contemporary astronomers peering through the telescopes into open space and by star faring voyages endeavoring in the inner and outer region of our star, as eyewitnesses confirm that not one single living entity has been found on any other planets so far thou they have found the existence of particles that they are capable to form life. This is evident beyond doubt.

For earth and seven other planets to orbit around the sun, our star the sun evidently claims some presuppositions. Earth for bearing and breeding, also claims some presuppositions.

For life to be formed on earth and we to walk upon its surface and breathe in its atmosphere we must leave Earth's fossil fuels and (hydro-carbons) as they are in their natural form, as carbons indeed photo-chemo-synthesize living matter. Also, core agent rich in electrons maintain the stability of earth's magnetic field and should be left where they are situated in their natural form. Uranium is one of the many agents, weak electrolyte in batteries means flat batteries or dead batteries. Changed electromagnetic ordinances of earth probably will bring death of life on earth.

It takes some millions upon millions of years for mineral hydrocarbons and fossil sources to be formed.

In addition, as deserts and water claim some three quarters of the earth's surface they reflect accordingly to stabilize sun's multitude of energy. This process of progression continues incessantly. To a certain degree the appropriate conditions of seasons on earth, allow the hydrocarbon emissions to photosynthesize the microscopic particles of living matter the right time at the right place, as star and solar winds co-operate with hydrocarbon's emissions, forming the gravity-particle dust of protoplasm of living matter that hovers over the biosphere, where the mentioned conditions descend the plasma-dust and spread the microscopic particles of living D.N.A. upon the fertile ground according to seasons.

Unfortunately, the methods of photovoltaic technological devices exploiting the powers of the sun to generate energy posing as large reflectors, will repel the particle dust to the higher levels above the biosphere, where according to cosmic ordinances it is not needed and obviously it will bring disastrous consequences to life on earth, as it would be look like an unwanted ectopic-pregnancy impregnation of the earth's biosphere.

Cosmic-sonic of star and solar winds as it mingles with the purling of rivers, the splashing sound of waterfalls, sea waves and wind, the chirping of birds and cricking of crickets in trees and plants form nature's orchestrated music, that stir the particle dust of photo-chemo-synthesis in order to improve DNA of living matter, something it would look like a cook's ladle stir its cooking meals. The sonorous pollution of wind turbines consisting an overwhelm commotion disturb the process of photo-chemo-synthesis of life. Also plants need fertilizers and not greasing spread from wind turbines. Animals, birds and every tiny animalcule need fertile grounds to survive. The sight of wind mills even scare animals and birds away

Dealing with alternative sources in the right direction in the field of energy, attention should be given to the effects of energy production and most importantly, to the utilization of the physical environment.

Evidently the prior art of energy production deprives earth from its legitimate claim.

Our planet is in real danger according to a comprehensive methodological survey made by all experts in the field of energy “That” took all factors into account.

It is evident that the existing technology which exploits sources of energy, such as fossil fuels, nuclear, solar, wind and geo-thermal powers adopts methods which are economically not reliable, are insufficient, illegitimate by world standards of safety and insufficient to produce the energy in demand to satisfy the six and a half billion people in near future worldwide.

An analysis of the development of the technology in the past and present times reveals the real picture of short-term advantages and long-term disadvantages of the existing renewable and non-renewable sources of energy, it is obvious in the real world we live in, the long-term disadvantages will eventuate sooner than experts estimate and will make the short term advantages seem like a ludicrous phantom.

The Earth's disorder continues at an accelerating rate. Despite this, people hope that some solution will be found at the nick of time to reverse the situation, though our planet is one step away from the real catastrophic collapse due to man's illegitimate interfere to earth's environmental ordinances.

### DISCLOSURE OF THE PRESENT INVENTION

Evidently, almost the ¾ of the earth's surface is covered by the hydro-gravity's massive resultant of balancing forces that has being converted to zeroed gravity-hydrostatic compression force sustained in massive stagnant waters enveloped by gravity-air-static compression force which totally covers the earth, where the latter is capable to hold in the air aerostatic aircrafts and upon gravity-hydrostatic boats, measured in kinetic mechanical horse power of billions of tones, which is capable to flood the earth with abundant and inexhaustible production of energy.

Compare to all renewable and non renewable sources of energy used so far to generate energy, gravity-hydrostatic is the most ideal source of energy and can be used by the present invented system with the characteristic etymology piston-chamber hydro-gravity engine as a working agent to generate the mechanical kinetic energy in demand worldwide.

So far due to deficiency of methods of technology said gravity-hydrostatic source of energy remain mostly unexploited as contemporary technology attempt to exploit sun's power or other naturally moving source of energy such as wind and moving water or significantly other unreliable universe and earthen ordinances of physical phenomenon To contemplate the ordinances of the universe and admit that they are endowed with an indeterminable and occult quality of force that probably could solve earth's energy problem in a friendly way it tells us absolutely nothing. To determine said ordinances and work out a mechanically workable method to solve the said problem in a friendly way it is a feat.

Literally, the present invention of the method consists the technological engineering system of mechanical kinetic production of multi-purpose use with the characteristic etymology piston-chamber hydro-gravity engine, comes at the right time to solve the environmental and energy problems once and for all worldwide and, to fulfill people's dream for a better future in a friendly environment, as the piston-chamber hydro-gravity engine exploits the inexhaustible force of action of hydro-gravity, which is naturally converted to stagnant gravity-hydrostatic tension of squashing compression sustained within the massive stagnant water confined in naturally made basins such as sea, lake, pond, or artificially made hydro-containers, where the piston-chamber hydro-gravity engine converts the gravity-hydrostatic force of stagnant energy, to an inexhaustible hydro-gravity energy of motion acting alternatively for and against gravity's motion and simultaneously to a mechanical kinetic force capable to activate electric generators of any capacity or to be used multi-purposely for other sort of work that demands mechanical kinetic force of action.

The present invention of the method consisting the technological engineering of piston-chamber hydro-gravity engines which enables the said hydro-gravity's stagnant gravity-hydro-static compression of massive stagnant liquids gathered in a basin, pond, ocean or artificially made container to be converted into an infinite source of energy and piston-chamber hydro-gravity engine, where the latter is capable of being installed in any location or place on earth to provide as much mechanical work as needed, capable to be used for hydro-electricity production or any other form of work, in a way that overwhelmingly satisfies even the most daring expectations of men's fantasy about energy production. Actually it starts from a point where experts in the field of energy think it is not possible.

Early of the twenty first century, we wonder how God made Cosmos from a zero point and life from not living matter. Our Greek mythology contains many tells of how. Our poets Horner, Hesiod, Orpheus and their followers call Oceanus (ocean) the origin of everything. It is said that Oceanus, endowed with inexhaustible occult powers make it capable of begetting like our rivers, our lakes and ponds. But Oceanus was not an ordinary river, lake, or pond, though he continued flowing back upon himself as he remained in his former place, which is not a place but only a flux of energy in the world and between the world and beyond, induced by micro tiny particle's velocity as they force to fill the vacuumed area provinces of chaos space time. Oceanus is the origin of everything and accompanied by a conceiving original partner the earth or any earth like planet consisting of solid, liquid, gaseous or air matter being capable of begetting and bearing life from not living matter continuously into infinity.

The coupled Oceanus and earth according to historical data can be translated, (as it has been translated by the inventor of the present invention of the method consisting the technological engineering of the system producing mechanical kinetic power with the characteristic etymology piston-chamber hydro-gravity engine,) as an Ocean of universal counter-poise particle winds, where in an attempt to fill the infinite space time of vacuumed space provinces that can not be filled, perpetually flow from all directions to all directions with their micro-tiny particles come to intersecting collision, or near coalition and finally end up to multi-micro-tiny spots of BARYTES (Greek word for gravity) to mean forceful crushing of micro-tiny particle collision, interpreting the etymological Greek word BAPΩ=(hit) in particular,

The present invention is a result of many years of deep thought and hard work. The issue of gravity is at the heart of the problem. By contemplating the issue gravity according to the theory that held sway for so long, one will realize that too many conglomerated word discrepancies do not match together. The Greek word “Baro” means to strike, to hit and beat; barytes, baro, baros, all these words are related words and meanings. Due to mistranslation the word gravity to original barytes creates a misunderstanding of the meaning that misrepresents the function of barytes=gravity. As said by contemplating both words BARYTES and GRAVITY, the first word can lead to the conclusion that gravity (barytes) is a universe wind consisting of micro tiny particles flowing from all directions to all directions with speed limits far greater than the speed of solar winds. Due to counterpoise wind velocity of the universe cosmic wind from all directions to all directions, direct collision or near collision of wind's micro-tiny atom particle (that is to say particles they do not split) is inevitable.

These collisions of micro-tiny atom particles form a multitude of micro-tiny nebulae globs of particle dust of atoms transparent to universe gravity=BARYTES wind and as the last penetrates this formation from all directions (like wind penetrates a sieve) create multitudes of barytes=gravity congestion of balancing resultant of force, which develop multitudes o different substances, each substance has its specific gravity congestion. Gravity is pushing this congestion from all directions (as like the wind push the sieve) to an epicenter, forming the liquid, solid and gaseous matter.

Matter is a good conductor to cosmic winds and as the last blow from all directions to all directions traffic congestion is created within the mater, traffic congestion is developing to gravity congestion. Different substances have their specific traffic gravity congestion translated as specific gravity=eidiko baros in Greek. Liquid water has its own congestion also and for said reasons is converted to hydro-gravity. (Gravity congestion translated as specific gravity of all sorts of matter). Hydro-gravity due to balancing of opposite resultant of forces created by the resistance of the solid walls of the natural basins or artificially made containers to hydro-gravity's motion, hydro-gravity converts to gravity-hydrostatic of outwards and inwards tense of squashing compression force sustained in massive stagnant liquids.

The aim of present invention of the method consisting the technological engineering of piston-chamber hydro-gravity engine is to exploit and fluctuates the zeroed resultant of gravity-hydrostatic compressing force, where simultaneously brings hydro-gravity to move homo-acting and counterpoise acting to gravity, capable to force chambers of any size floating on the surface of hydro-gravity, to sink and emerge within the gravity-hydro-static squashing compression of mass stagnant water of sea, lake, pond or artificially made container with a continuous reciprocating motion.

As first step is to fluctuate the gravity-hydrostatic balanced resultant of forces of gravity-hydrostatic tension of squashing compression exist within the liquid fill the natural basins or interior area of hydro-chamber's by alternatively separating a portion of it, convert it to specific force of hydro gravity and, by diminishing the first and increasing the second oblige the two imbalanced forces to make a chamber to sink within the gravity-hydrostatic tension of stagnant squashing compression, where simultaneously the gravity-air-static squashing compression follow the sinking of the chamber creating a column of air within the gravity-hydrostatic squashing compression above the chamber As second step in turn as the chamber has reached the predetermined depth according to the method consist the technological engineering of piston-chamber hydro-gravity engine, alternatively fluctuates the two counter forces, meaning the resultant of gravity-hydrostatic force and specific gravity force of piston-chamber by diminishing the second and converts gravity-hydrostatic tension of stagnant squashing compression to hydro-gravity moving force of action, working as a counteracting force moving against gravity, which as it overwhelms gravity, push the chamber from underneath and force the latter to ascent back to surface, through the liquid-vacuum column substituted with air that has being created during the chamber's sinking.

This practice go on and on repeatedly and thus, the chamber being forced by the two alternating forces of action, reciprocates in and out the gravity-hydrostatic squashing compression continuously in alternative motion inside cylinder-chambers, in depths determined by the said method consisting the technological engineering of piston-chamber hydro-gravity engine, that at the same time converted to an axial rotation that can be used multi purposely, to satisfy even the most daring expectations of men's fantasy about energy production. Actually it starts from a point where experts in the field of energy think it is not possible.

### DETAILED DESCRIPTION OF THE PRESENT INVENTION IN BRIEF

The technological system piston-chamber hydro-gravity engine, that eventuates the present invented method consisting its technological engineering characterized, by the embodiment of very particular mechanisms, assembling the embodiment of a single engine of kinetic power production of multi-purpose use, composed of the hydro-container which at times is used as a mean to form the three dimension shape of the liquid matter that fill the latter's interior area, capable to develop the gravity-hydrostatic tension of inwards and outwards squashing compression, suitable to be used exclusively as the working agent sufficient to activate the piston-chamber hydro-gravity engine, or differently said hydro-container serves as a water control of the inwards and outwards tension of squashing compression of the liquid mater of the sea, lake, or ponds and make it suitable to be used as a working agent of the method consisting the technological engineering system of piston-chamber hydro-gravity engine. When the liquid matter content of the hydro-container is been used exclusively, the latter one is totally water-tight, when the hydro-container is to be used as water-controller of the inwards and outwards tension of the squashing compression of the liquid mater sustained in sea-water lake or ponds, then the hydro-container is partly water-tide, as at its bottom part is placed a protecting net-grill, that protects its interior area from entering unwanted objects or aquatic life, the cylinder-chamber fluctuator displacer separator of hydro-gravity that fluctuates hydro-gravity's force of action now to a homo-acting to gravity and then counterpoise motion of gravity's force, comprising an embodiment of a cylinder-chamber-trunk, a valve-chamber which is hermetically adjusted from its one side at the bottom side of the cylinder's trunk, where inside the valve-chamber there is adjusted the valve's operation mechanism, which operates the valve of the valve-chamber which in turn seals and unseals hermetically the one bottom side of the cylinder-chamber-where the valve-chamber is adjusted, the interior area of the cylinder-chamber is appropriately made as to allow a piston-chamber to reciprocate freely backward and forward within its interior area like a piston of piston-motors reciprocates forward and backward.

The piston-chamber resembling an upside down bucket and looks like a piston of a piston motor and being capable to reciprocate freely upward and downward inside the cylinder-chamber fluctuator separator of the gravity's hydrostatic squashing compression, at a first period of its reciprocation as hydro-gravity's piston-chamber oppressor and at a second period of its reciprocation as a piston-chamber reactor to hydro-gravity's counterpoise force of action to gravity force of action, appropriately made according to present invented method consisting the technological engineering of the piston-chamber-hydro-gravity engine, the piston-chamber's top-side one is permanently hermetically plugged, where at the other bottom side there is adjusted a disc-valve with its operation mechanism made accordingly, capable to hermetically seal in the liquid stuff which is inside the interior area of the piston-chamber or release it. On its topside of the piston-chamber that is hermetically plugged there is fixedly adjusted a connecting-rod's base with its pin shaft, from where the one side of a connecting rod is articulated, with its stem extending upwards,

The vessel-crank-camshaft-chamber that is a particular water tide embodiment accessory of piston-chamber hydro-gravity engine consisting of moving and immobile parts, where with its bottom exterior surface of its frame-panel is fixedly adjusted hermetically at the top-side of a hydro-container, where at an opening of this very frame panel is fixedly adjusted hermetically with its top-side said cylinder-chamber fluctuator separator of gravity-hydrostatic squashing compression, which remains permanently open to allow its interior area to correspond with the interior area of the vessel-crank-cam-shaft chamber, where through it the connecting-rod of the piston chamber is capable to move freely as with its other side is articulated to the crank of the crank-shaft, where at the jumping cam of the crank-cam-shaft is touching the piston of a piston-pump, which hydraulically activates the valves. The upper side of the vessel-crank-camshaft is closed hermetically with a top cover where air filters are fitted to it. As the piston-chamber reciprocates the pipe that hydraulically connects the piston pump with the mechanism that puts in action the piston-chamber's disc-valve is made of elastic material of threaded shape. The cylinder-chamber fluctuator separator trunk is extending vertically downwards, embedded in the gravity-hydrostatic squashing compression of the liquid matter that fill the hydro-container's interior area permanently, with its other end where the valve-chamber is adjusted hermetically fixed to hover over the bottom of the water-container in a certain distance. Sometimes supporting legs are used to support said cylinder-chamber at this bottom side of the hydro-container, also, the side with which the cylinder-chamber fluctuator separator is adjusted and hermetically fixed at the vessel's crank-cam-shaft chamber remains permanently open, to allow the correspondence of the interior area of the vessel-crank-cam-shaft-chamber with the interior area of the cylinder-chamber, (which area is the one that is above the top side one of the piston-chamber that is permanently plugged), there for the air can move free from one area to the other as the piston-chamber reciprocates upwards and downwards inside the cylinder-chamber that is permanently embedded in the liquid stuff that fills the hydro-container's interior area.

The working mode of the piston-chamber hydro-gravity engine consist of two periods of one complete reciprocation of the piston-chamber within the barite-hydro-static=(gravity-hydrostatic) tension of the squashing compression of the concentrated gravity-hydro-static's stagnant bulky liquid load which fill the hydro-container, through the cylinder-chamber.

The first period is the one of the piston-chamber's immersion inside the cylinder-chamber fluctuator separator of the gravity-hydro-static tension of squashing compression, due to hydro-gravity's oppressive force of the piston-chamber caused by liquid's specific gravity that is hermetically sealed inside the piston-chamber, that is converted to water specific gravity force of action and, the second one period is the one of the piston-chamber emersion through the liquid's vacuumed area inside the cylinder-chamber fluctuator separator, above the permanently plugged topside of the piston-chamber, caused by the gravity-hydro-static's tension of squashing compression that fills the water-container's interior area, that is converted to hydro-gravity's counterpoise force of action to gravity, which works now as an overwhelming counterpoise force of action to gravity and push the piston chamber to move back to its initial spot where the first period start.

According to the present invented method consisting the technological engineering of piston-chamber hydro-gravity engine, the mode of working order is determined by the mode of its appropriate made accessories assembling together to an embodiment of a single engine capable to exploit gravity, the mode of their cooperation together in successive correspondence one with the other very-particular accessories to form an embodiment of a single engine, the exact timing of their working correspondence order and, the exact materials they are made from, that by now will be described in detail with reference to the attached drawings.

### BRIEF DESCRIPTION OF THE DRAWINGS OF THE DIAGRAMMATIC CONFIGURATION OF THE SYSTEM OF PISTON-CHAMBER HYDRO-GRAVITY ENGINE

The aim of the attached drawings is to be used as to exhibit the mode of the method consisting the technological engineering of the piston-chamber hydro-gravity engine and the mode of working order of the piston-chamber hydro-gravity engine as is has been dictated by the method and not to confine the present invention to them.

FIG. 1 in diagrammatic view exhibits one of the many ways of the technological engineering of a piston-chamber (1) can be, which is a very particular accessory of the piston-chamber hydro-gravity engine, which piston-chamber (1) in a way looks like an upside down bucket. The distinguishable parts of the piston-chamber (1) of FIGS. 1, 1a & 1b are the disk-valve (2) with its piston hydraulic gear (3) the connecting rod (4) that transmits and converts the piston-chamber's reciprocating motion to crank-shaft's rotation, the base (5) which is fixedly adjusted at the outside of the top side of the piston-chamber (1) which is permanently plugged hermetically, the pin-shaft (6) where the one end of the connecting rod (4) is articulated from. The descriptive diagrammatic view of the configuration 1a that is at the left side of the page of FIG. 1 exhibits the disc-valve (2) open and, the configuration 1b that is at the right side of the page of FIG. 1 exhibits the disc-valve (2) closed.

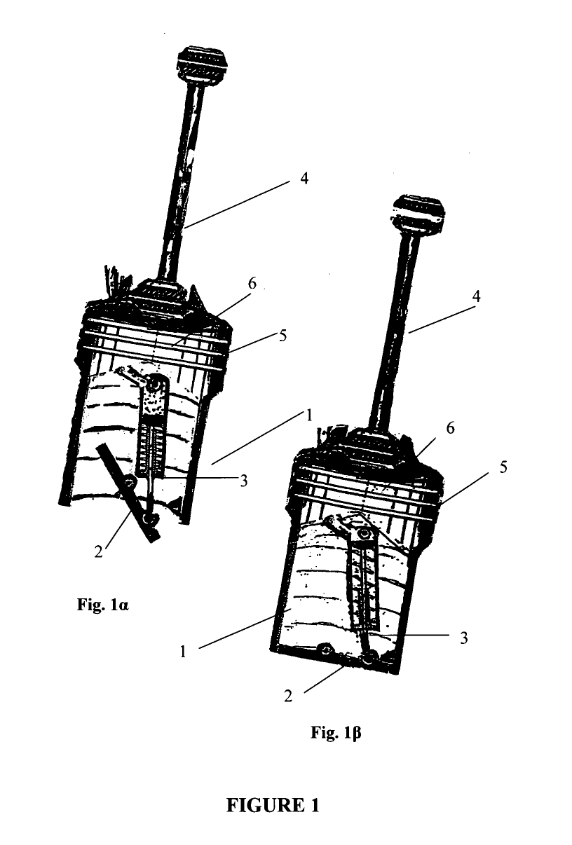

FIG. 2 in a diagrammatic view exhibits the very particular accessory embodiments of the piston-chamber hydro-gravity engine, where the hydro-container (7) is the particular accessory that gathers and sustains the gravity-hydro-static's resultant of force, converted to gravity-hydrostatic tension of squashing compression existing within its liquid matter that fill said hydro-container's (7) interior area and, create the ordinances capable to make the piston-chamber (1) of FIG. 1 to descend and ascend within the gravity-hydrostatic tension of squashing compression, through a cylinder-chamber's (15) interior area that is a particular embodiment accessory of the piston chamber hydro-gravity engine, the embodiment accessory vessel crank-cam shaft chamber (8), where with its bottom panel's exterior area is hermetically fixed on the top side of said hydro-container (7), with its moving and immobile accessories which are, the crank-cam-shaft (9) inside the vessel crank-cam-shaft chamber (8), placed to a crank-cam-shaft basses (10) in crankshaft bearings which hold the crank-cam-shaft (9) firmly fixed in the vessel crank-cam-shaft chamber (8), the crank (11) of the crank-cam-shaft (9), the cams (12) of the crank-cam-shaft (9), which activate the hydraulic piston pump (14), which in turn send hydraulic energy through the pipes (13).

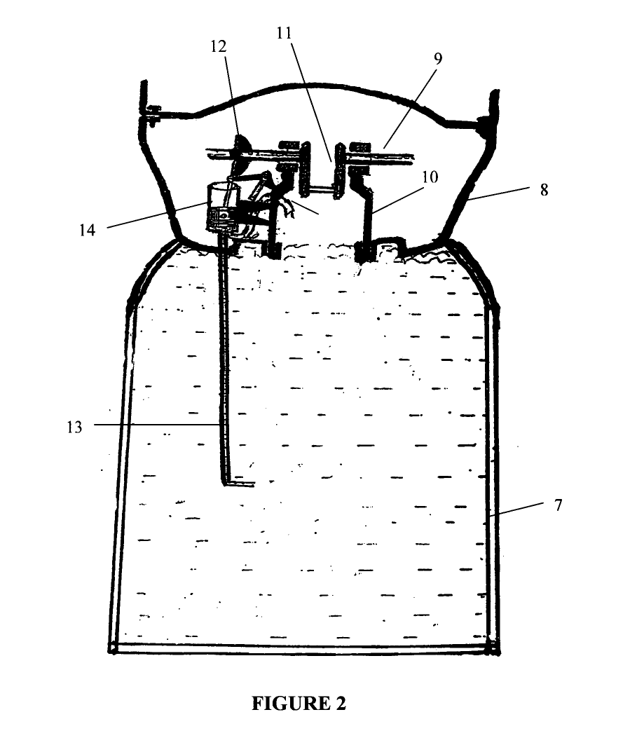

FIG. 3 in a diagrammatic view exhibits the embodiment of a cylinder-chamber-fluctuator-displacer-separator (15) (consisting a very particular mechanism of the piston-chamber hydro-gravity engine) the valve-chamber (16) which is an immobile embodiment of the cylinder-chamber (15), the valve (17) with its connecting rod consisting a moving accessory of the valve-chamber (16), where the latter consist a steady accessory of the cylinder-chamber-fluctuator-separator (15), the embodied valve gear (18) of the valve (17), the conduits (19) which are immobile embodied accessories of the cylinder-chamber-fluctuator-displacer separator (15), where the latter is an immobile accessory embodiment of piston-chamber hydro-gravity engine with its moving and immobile accessories, where with its top side is fixed hermetically bolted at an opening that is at the bottom side of the vessel crank-cam-shaft chamber (8), with its trunk that include its embodied accessories extending downwards vertically in the center of the hydro-container (7), immersed inside the gravity-hydrostatic tension of squashing compression that fills the interior area of the hydro-container-container (7), where within the cylinder-chamber's interior area the piston-chamber (1) of FIG. 1 can reciprocate between the B.D.C. (24) and T.D.C. (25) area.

FIG. 4 in a diagrammatic view exhibits the piston-chamber (1) situated inside the cylinder-chamber fluctuator displacer separator (15) of the FIG. 3, with the other tip of the connecting rod (4) articulated at the crank (11), where at this stage the embodiment of the piston-chamber hydro-gravity engine that eventuates the method of technologically engineering piston-chamber-hydro-gravity engine is completed.

FIG. 5 in a diagrammatic view exhibits the piston-chamber hydro-gravity engine performing the first period of its function, as the piston-chamber (1) is immersing in the gravity-hydrostatic tense of squashing compression existing within the bulk concentrated liquid matter that fill the interior area of the hydro-container (7), through the interior area of the cylinder-chamber (15), where at this stage of function the disc-valve (2) and disc-valve (17) are closed.

FIG. 6 in a diagrammatic view exhibits the piston-chamber hydro-gravity engine performing the second period of its function, as the piston-chamber (1) is emerging to surface from inside the gravity-hydrostatic tense of squashing compression existing within the bulk concentrated liquid matter that fill the interior area of the hydro-container (7), through the interior area of the cylinder-chamber (15), where at this stage of functioning the disc-valve (2) and disc-valve (17) are open.

FIG. 7 in a diagrammatic view exhibits a four cylinder piston-chamber hydro-gravity engine representing of how the multi piston-chamber hydro-gravity engine's crank-cam shaft (9), make one complete rotation of 360° degrees in one reciprocation of all piston chambers (1) together in a successive complete cooperation with each other as the cranks (11) are in different angle of inclination.

FIG. 8 in a diagrammatic view exhibits a four-cylinder piston-chamber hydro-gravity engine apply the present method of its technological engineering, by exploiting the gravity-hydrostatic tension of squashing compression that exist within the liquid matter that is confined and fill exclusively the interior area of the hydro-container (7).

FIG. 9 in a diagrammatic view exhibits a four-cylinder piston-chamber hydro-gravity engine, similar to FIG. 8 applying the present method of its technological engineering of piston-chamber hydro-gravity engine, by exploiting the gravity-hydrostatic tension of squashing compression that exist within the liquid matter of the sea lake pond or other natural basins, where the bottom side panel of the hydro-container (7) is replaced by a protecting grille (30), to (prevent) the entrance of unwanted objects or aquatic life within the interior area of the water-container (7), where its frame and frame's panels are appropriately made as to make it capable for its light displacement to allow it to float, as it is submerged within the gravity-hydrostatic tension of squashing compression, with the bottom exterior side of the vessel crank-cam-shaft chamber (8) touching the surface of the liquid matter of natural made basins as the vessel crank-cam-shaft chamber (8) by now serves as floating-mean of the piston-chamber hydro-gravity engine. In occasions that by no means it is possible to be firmly supported on the bottom of these depths of the lake, sea, or pond, hawsers (26) are added connecting the piston-chamber hydro-gravity engine to holding-weight (26) situated on the depths preferably made of concrete, in addition springs (28) are added to smooth the water waves.

### ENUMERATED NOMENCLATURE ELUCIDATION OF THE ACCESSORIES INCLUDED IN DRAWINGS

1. Piston-chamber (oppressor and reactor of hydro-gravity)
2. Piston-chamber valve (disc-valve with its piston-hydraulic gear).
3. The hydraulic gear which activates the piston-chamber's valve.
4. Piston-chamber connecting rod (connecting the piston-chamber with the crank-cam shaft).
5. The piston-chamber's topside hermetically plugged and the connecting rod base.
6. The pin-shaft of the piston-chamber's connecting rod base.
7. The hydro-container accumulator of the gravity-hydro-static's tension of squashing compression
8. The vessel crank-cam shaft chamber.
9. The crank-cam shaft.
10. The crank-cam shaft base with its bearings.
11. The crank-cam shaft's crank.
12. The crank-cam shaft's cam.
13. The hydraulic pipe of the piston-pump to valve-chamber's valve gear.
14. Hydraulic or air piston-pump.
15. The cylinder-chamber fluctuator displacer separator of gravity-hydrostatic tension of squashing compression.
16. The cylinder-chamber's valve-chamber.
17. The valve-chamber's piston-valve
18. The hydraulic gear that activate the valve-chamber's piston-valve
19. The conduits of cylinder-chamber's interior oppressed liquids by the piston-chamber.
20. The hydraulic pipe from the piston-pump to piston-chamber's disc valve gear.
21. The crank-cam-shaft's orbit diameter.
22. The point of 180° degree of crank-cam-shaft's crank orbit.
23. The point of 360° degree of crank-cam-shaft's crank orbit.
24. T.D.C.=top dead centre of piston-chamber's (1) reciprocation where its top plugged side levels with the hydro-container's (7) liquid's level and the conduit's (19) top end side.
25. B.D.C.=bottom dead centre of piston-chamber's (1) reciprocation where its bottom trunk-side that is touching hermetically the interior trunk side of the cylinder-chamber (15) is reaching a little over the conduit's (19) other bottom side which is hermetically fixed to the cylinder-chamber's trunk.
26. The hawsers they support the piston-chamber hydro-gravity engine on surface of natural basins.
27. The hawser's balancing and stabilizing weights.
28. The balancing of resistance smoothing hawser-springs.
29. The crank-cam shafts removable top cover.
30. The hydro container's protecting grill

### DETAIL DESCRIPTION OF THE INVENTION WITH REFERENCE TO DRAWINGS

The detailed description of the present invention with references to drawings that describes the working mode of technological engineering of the piston-chamber hydro-gravity engine determined according to the present invented method, only serve as explanatory example and by no means to confine the present invention to them, particularly said description with references to drawings is to illustrate the picture of the said method and mode of the technological engineering of the piston-chamber hydro-gravity engine, the mode of how it exploits the gravity-hydrostatic and hydro-gravity's force and, the how the later is converted to a mechanical source of renewable kinetic energy capable to be used in various ways and not to confine in them the said method and the system of the piston-chamber hydro-gravity engine that apply the method of its technological engineering.

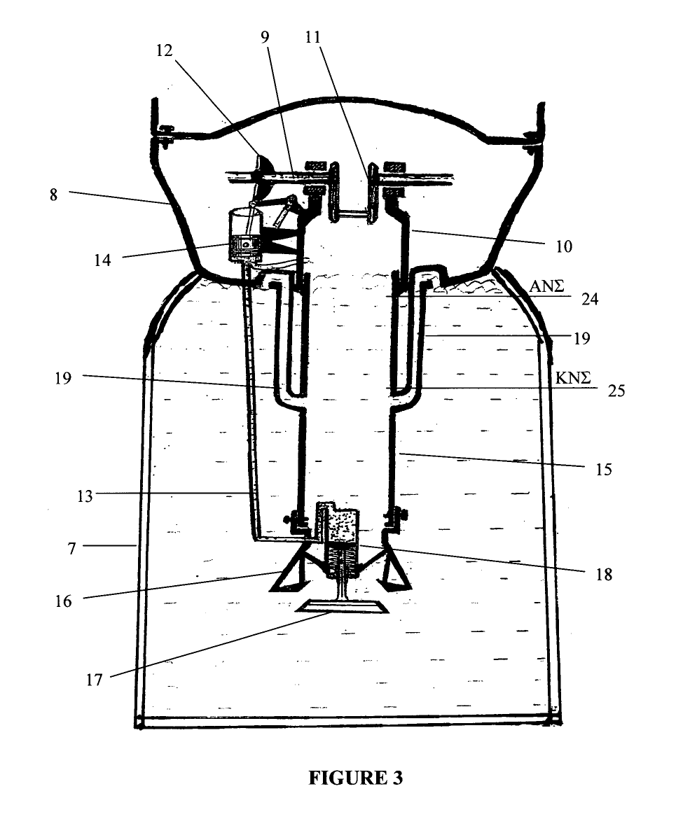

In FIG. 3 diagrammatical configuration is presented a hydro-container (7) filled with liquid matter hermetically insulated.

The said vessel-crank-cam chamber (8) with its bottom exterior side is resting hermetically fixed on the topside of said hydro-container (7), where at the interior area of said vessel crank-cam shaft chamber (8), a crank-cam shaft (9) is resting adjusted appropriately on its bearing bases (10), as to be capable to revolve, a crank (11) adjusted in an angle of a certain degree at a certain distance over the open top side of the said piston-chamber fluctuator separator (15) of gravity-hydrostatic tension of squashing compressions development sustaine within the liquid matter that fill the interior area of the hydro-container (7), which open top side of said piston-chamber (15) (with its outer side) is adjusted and hermetically fixed to an opening of equal dimensions that is at the bottom side panel of the vessel crank-cam shaft chamber (8), where the rest of its said cylinder-chamber's (15) trunk with its accessory parts named valve-chamber (16), disc valve (17), hydraulic gear (18), extending vertically downwards in the middle of said hydro-container (7) and, a conduit or conduits (19) where the latter from their outside one bottom side are hermetically adjusted at the sides of cylinder's trunk (15), with their trunk extending upwards where their other topside levels with the liquid's matter surface of the hydro-container (7) and the T.D.C. of piston-chamber's reciprocation.

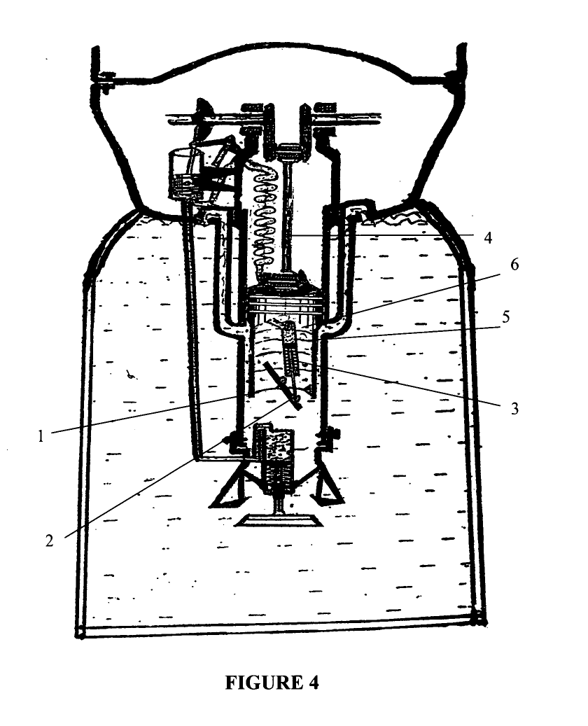

In FIG. 4 configuration is presented the said piston-chamber (1) situated within the interior area of the cylinder-chamber (15), where at the bottom of said piston-chamber (1) there is adjusted the piston-chamber's disc-valve (2), where inside the said piston-chamber's area there is fixed and appropriately adjusted the said disc-valve's hydraulic gear (3), that activate said disc-valve (2), and said conducting rod's (4), where the latter's bottom tip side is articulated at the pin-shaft (6) of said connecting rod's piston-chamber base (5), which in turn is fixed adjusted at the said piston-chamber's (1) hermetically plugged topside and, the other top tip side of said piston-chamber's connecting rod is articulated to crank (11) thus connecting the piston-chamber (1) with the crank-cam-shaft (9) crank.

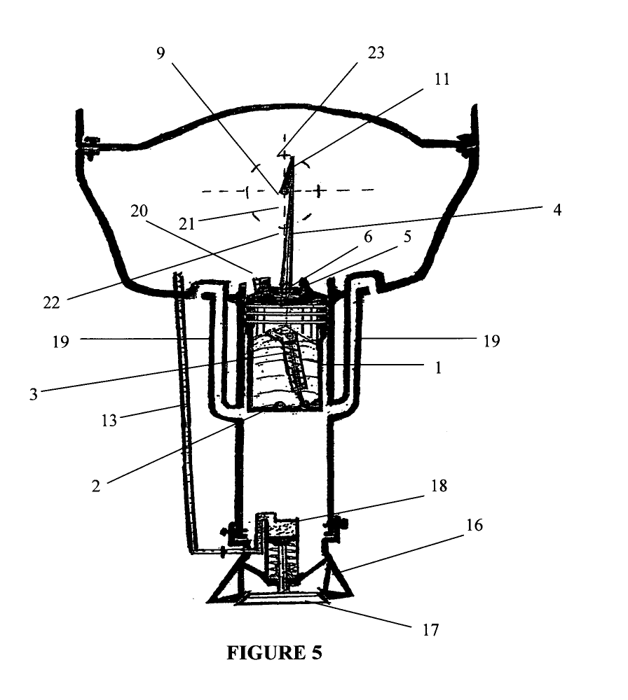

As FIG. 5 exhibits, the piston-chamber's disc valve (2) and disc-valve (17) are hermetically closed, preventing the gravity-hydro-static's squashing compression of the liquid matter that is confined and fill the interior area of the hydro-container (7) to communicate with the interior area of said cylinder-chamber fluctuator displacer separator (15), the interior area of the conduits (19) and, the interior area of piston-chamber (1) which is adjusted hermetically inside the cylinder-chamber's (15), capable to reciprocate like the piston of piston motors reciprocate. Said crank (11) that is connected with the piston-chamber (1) by said connecting rod (4) to have past the 360° degree of its orbit (23) and, the piston-chamber (1) to have started its immersing period of its reciprocation, the cam (12) of said crank-cam shaft to have release the piston of the piston-pump (14), which in turn had activated the hydraulic gears (3) and (18), these in turns force the disc-valves (2) and (17) to close.

At this stage of function of piston-chamber-hydro-gravity engine, according to the method consisting the technological engineering of piston-chamber hydro-gravity engine, its very particular embodied accessory the piston-chamber (1) in reciprocal share of cooperation with the rest of the depended very particular accessories, which altogether constitute a single piston-chamber hydro-gravity engine, curry out the first period of piston-chamber's reciprocation within the tension gravity-hydrostatic squashing compression, (forced by the particular hydro-gravity's force that is confined and fill the interior area of the piston-chamber, where the last's disc-valve seals it in hermetically and, inevitably gravity has been transformed to a solid force of action that is equal to the quantity of the liquid's specific gravity) from inside the cylinder-chamber (15) as the latter's closed disc-valve prevent the communication of the gravity hydro-static squashing-compression force that exist within the liquid's matter that fill the interior area of the hydro-container (7) with the interior area of cylinder-chamber fluctuator separator (15).

Particularly, in relation to the successive cooperation of the working steps of the very particular accessories of the piston-chamber hydro-gravity engine's working system, the closed valve (17) and (2) of the cylinder-chamber (15) and piston-chamber (1) according to present invented method, create the alternating conditions of successive working order, where the cylinder-chamber fluctuator displacer separator's (15) valve-chamber's (16) closed disc-valve (17) prevent the correspondence of the gravity-hydrostatic tension of squashing compression exist within the quantity of the liquid matter that fill the interior area of the hydro-container (7), from the liquid matter that fill in the interior area of the cylinder-chamber (15), the interior area of the piston-chamber (1) and, the interior area of the conduits (19).

As a result of it, automatically the cylinder-chamber fluctuator displacer separator (15), working as solid force displace a portion of the gravity-hydrostatic tension of squashing compression of the liquid matter that fill the interior area of the hydro-container (7) equal to cylinder-chamber's (15) dimensions, due to it, the gravity-hydrostatic tension of squashing compression that exist within the liquid matter that fill the interior area of the hydro-container (7), which apply inwards and outwards and to all directions force of action equal to its specific gravity force of gravity-hydrostatic quantity tension of squashing compression, apply counter force at the exterior trunk wall of the cylinder-chamber (15) including to the exterior side of the disc valve (17), which gravity-hydrostatic squashing compression force, is neutralized by the static force resistance of the cylinder-chamber (15) and its valve (17) of its valve-chamber to a resultant of forces as at this stage is closed, at the same time the closed disc-valve (17) insulate a small portion of gravity-hydrostatic tension of squashing compression within the interior area of the cylinder-chamber fluctuator displacer separator (15), piston-chamber's (1) closed disc-valve (2) insulate hermetically part of cylinder-chamber's (15) liquid matter living the rest of the liquid matter insulated underneath the piston-chamber's (1) disc-valve (2), due to it and as the piston-chamber (1) quantity of the liquid matter is hermetically insulated within latter's interior area all together is converted to a solidified hydro-gravity specific gravity force, that apply squashing compression force upon the portion of the liquid matter that is insulated inside the cylinder-chamber fluctuator displacer separator (15), underneath the piston-chamber's (1) disc-valve (2). The liquid matter inside the cylinder-chamber (15) undergoing squashing compression by the piston-chamber's disc-valve (2), the liquid matter's particles (due to particularity of liquids where the articulation of their particles is not firm and there for any portion of liquid matter can be easily separated or change shape with all most no effort) all together and each on separate tent to escape to all directions and apply pushing force at the cylinder-chamber's (15) interior walls, the piston-chamber's (1) disc valve (2), the valve-chamber's (16) disc-valve (17) and, at the conduit's (19) hydro gravity's specific gravity of the liquids fill the latter's interior area, as the conduits'(19) hydro gravity counter force resistance to applying piston-chamber's (1) hydro-gravity force of action one has been arranged by the method consisting the technological engineering of the piston-chamber engine to be less, the conduit's (19) force becomes a weaker counter force power component of piston-chamber's (1) counter force of action power component apply to cylinder-chamber interior liquid's squashed gravity hydro-static, as a result the liquid matter of cylinder-chamber escapes through the conduits and flow back to hydro-container (7) over its surface level from the top side of conduits (19), allowing said piston-chamber (1) to descend within the latter's gravity hydro-static tension of squashing compression, from inside said cylinder chamber ((15), as said, the latter's one disk valve has isolated the hydro-gravity's tension of squashing compression of hydro-container (7) outside from its interior area and the hydro-gravity of piston-chamber (1) specific gravity activity of the liquid matter that is insulated hermetically inside the piston-chamber (1) and the latter is capable to overwhelm the conduit's weaker power component and, as the liquid matter from inside the piston-chamber (15) drain through conduits piston-chamber hydro-gravity's specific gravity, force the piston-chamber down to its immersion,

In the meanwhile, as the piston-chamber (1) descend within the hydro-container's (7) gravity hydrostatic tension of squashing compression through the inside area of said cylinder chamber ((15), automatically within the latter's interior area above the plugged side of piston-chamber (1) create a liquid's matter vacuum area, as the piston-chamber (1) by its connecting rod (4) tug the crank (11) to its track motion the latter force the crank-cam shaft (9) to turn.

The first period of the reciprocating motion of piston chamber (1) within the gravity-hydrostatic tension of squashing compression trough the said cylinder-chamber's (15) interior area as it is induced by the hydro-gravity's force of the specific gravity of he liquid matter that is hermetically sealed inside the said piston-chamber's (1) interior area would continue until the said piston-chamber's hydro-gravity force would equalized with the conduit's (19) hydrostatic force power component or until the piston-chamber's (1) vertical side one that touch the said cylinder-chamber's one vertical interior side in a hermetical reciprocating motion would reach the conduit's (19) mouth with which the said conduits are hermetically fixed adjusted to said cylinder-chamber's (15) trunk and block both interior area communication,

There for the present invented method consisting the technological engineering of piston-chamber hydro-gravity engine settle this as it is arranged by the said method that the truck of the crank's (11) diameter circumference to be slightly smaller than the distance of the T.D.C. (24) to the spot where the conduits (19) area are fixed adjusted to said cylinder-chamber's trunk area and thus as soon as the crank (11) has completed its 180° degree track restrain the piston-chamber's down motion by its connecting rod before said circumstances occur,

The positive consequence of piston-chamber's (1) restrained immersion caused by the crank's track's (11) diameter length convoke four prescribed cooperation provisions of the method consisting the technological engineering of piston-chamber hydro-gravity engine which are inevitably necessary for piston-chamber's first period reciprocation inside the said cylinder-chamber's (15) interior area to be occurred,

The first is to stop the downwards reciprocating motion of piston chamber (1) within the gravity-hydrostatic tension of squashing compression trough the said cylinder-chamber's (15) interior area at a point before all opposite conflicting forces be able to cam to a zero point of equalized resultant of force, namely the hydro-gravity force power of the liquid matter that is inside the conduits (19) to the hydro-gravity's force of the specific gravity of liquid matter that is hermetically sealed inside the said piston-chamber's (1) interior area where due to it has been converted to a united solidified piston-chamber (1) force,

The second is to stop the descend of the piston-chamber (1) before the latter's vertical side one that touch the said cylinder-chamber's vertical interior side in a hermetical reciprocating motion would have reach the conduit's (19) mouth with which the said conduits are hermetically fixed adjusted to said cylinder-chamber's (15) trunk where inevitably would have block both of their interior area communication of cylinder-chamber (15) with the conduits (19) one,

The third is to allow the crank (11) to reach its 180° degree track before the said resultant of force cause the piston-chamber to cam to a dead stop,

The fourth is that the piston-chamber (1) mast continue to sustain its hydro-gravitation force power strength to the crank (11) when the last is in its 180° spot of its track so as to mace it possible for the said crank (11) to sustain its force strength to crank-cam shaft (9) that in turn the last will be able to make the cam (12) capable to activate the piston-pump which in its turn will pump force the disc-valves (2) and (17),

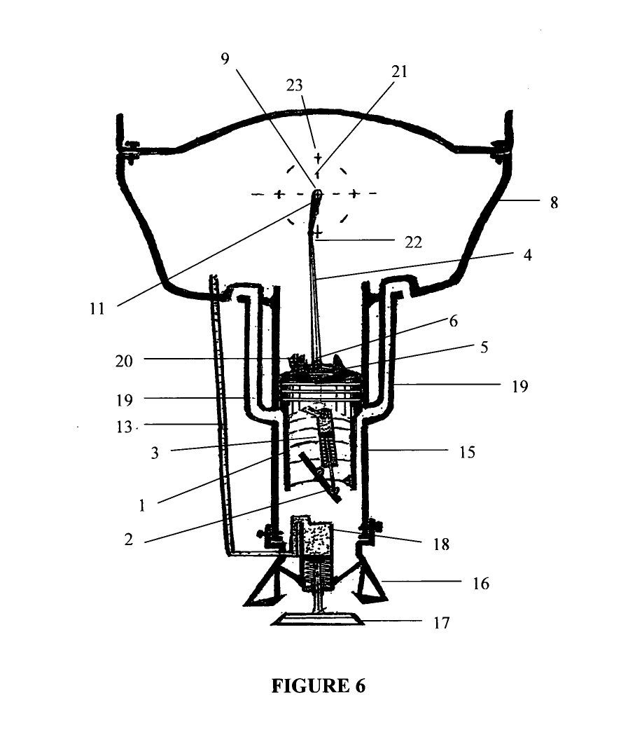

As it is depicted in FIG. 6 said piston-chamber's (1) disc-valve (2) and valve-chamber's (16) disc-valve (17) are open, where the piston-chamber (1) has started its emersion from the gravity-hydro-static tension of squashing compression inside the cylinder-chamber's interior area where the crank (11) approximately has past its 180° degree track and is in its way towards its complete track of 360° degree track, said development has been occurred due to positive consequences of the first's period of the working order of the piston-chamber's (1) reciprocation as the last's continuous force of action applying to crank (11) induced by its said less track diameter difference (compared to the distance of said piston-chamber's first period of its reciprocation) that has made it possible for crank (11) to turn the crank-cam shaft (9) to its 180° degree axial rotation which in its turn made the its cam to activate to activate the piston-pump (14) as the piston-chamber continues to apply force of action at the crank (11) where the said piston-pump hydraulically activate the disc-valve's (2) and (17) hydraulic gears (3) and (18) by the hydraulic pipes (20) of piston-chamber (1) and (13) of valve-chamber (16) that in turn said hydraulic gears in turn activated the said valves (2) and (17) to open at the same time within some fractions of a minute's second,

Due to it, as said piston-chamber's disc-valve (2) and said valve-chamber's disc valve (17) open, said gravity-hydro-static tension of squashing compression of said hydro-container (7) where it apply squashing compression force to cylinder-chamber's exterior walls is set free to communicate with the interior area of said piston-chamber (1) and cylinder-chamber (15), where jointly combined to a united gravity-hydro-static tension of squashing compression, as a result of it said gravity-hydrostatics' tension of squashing compression is transferred interiorly through the disc-valves (2) and (17) to piston-chamber's (1) interior top side (5) that is permanently hermetically plugged, where it apply dynamic force with all its strength, as said piston-chamber's (1) disc valve (2) opening has released its hydro-gravity's force of action of its liquid matter specific gravity and is not capable enough to resist the main force of the hydro-container's gravity hydro-static tension of squashing compression witch now has been converted to hydro-gravity's force of action working counter force to gravity's force of action that is applying force upon the empty piston-chamber (1) which is not capable to resist and finally ascend through the cylinder-chamber's (15) liquids matter vacuumed area above said piston-chamber's (1) top side hermetically plugged area that is created due to first period of its immersion, and in turn the piston-chamber (1) by its connecting rod (4) push the crank (11) towards its 360° degree track and force the crank-cam-shaft (9) to accomplice its 360° degree revolution,

As in FIG. 6 diagrammatically exhibits the crank (11) is about to complete its 360° degree track, where the piston-chamber's (1) hermetically plagued top side (5) is approximately close to level with the conduit's (19) top side that levels with hydro-container (7) liquid matter's surface level that is externally of said cylinder-chamber's (15) interior area, and the latter's open top side,

As crank (11) complete its 360° degree circumference track its diameter's length (21 oblige said piston-chamber (1) to end the latter's upwards motion of its reciprocation just before its hermetically plugged top side (5) come to level with the liquid matter's of hydro-container's (7) and conduit's (19) top-end side and there for the gravity-hydro-static's tension of squashing compression (that in the second period of piston-chamber's (1) reciprocating period is acting as hydro-gravity working counter to gravity's force that is forcing said piston-chamber to move upwards where the latter one in its turn apply force to crank (11) and by it to crank-cam-shaft) continue to be active,

Where at this stage as the second period of piston-chamber's (1) reciprocate motion is completed, the disc-valves (2) and (17) will close at the same time forced by the said crank-cam-shaft's (9) cam (12) that has completed its 360° degree motion and release piston-pump's (14) piston, that in its turn cease its hydraulic or air compression to valves gears (18) and (3) letting the springs of said gears to force disc-valves (2) and (17) close and thus the second period of reciprocating piston-chamber (1) upward moving end for the first period downward to start.

For said piston-chamber hydro-gravity engines to work certain principle requirements and analogical standards of its construction mast be applied strictly according to the present invented method that is consisting its technological engineering.

The tolerance between the vertical exterior wall or a part of the vertical wall of said piston chamber (1) and the interior vertical wall of said cylinder chamber fluctuator displacer separator (15) must be adjusted perfectly so as not to allow the water which is inside said cylinder chamber (15) underneath said disc valve (2) not to leak through to the upper area above the top hermetical plugged side of said piston chamber (1); also the exterior walls of said piston chamber (1) and the interior walls of said cylinder chamber (15) between the area where said conduits (19) are hermetically adjusted to said cylinder chamber trunk (15) and T.D.C. (24) dead end point of said piston chamber (1) reciprocation of upward and downwards move must be finely turned and polished as to allow said piston chamber (1) to reciprocate hermetically (like pistons of piston motors reciprocate) and any liquid leakages to be prevented,

The length of the diameter of the track circle (21) of said crank (11) mast be slightly smaller than the length of the distance of piston chamber's (1) reciprocating upward and downward of itch period motion inside cylinder-chamber fluctuator displacer separator (15) so as crank (11) to be able to stop piston-chamber (1) downward reciprocating motion as soon as crank (11) has reached its 180° degree track circle so as the existence of piston-chamber's (1) force of action to be sustained and there for a serial of applying force of action from piston-chamber's (1) to crank (11) from crank (11) to crank-cam-shaft (9) and vice versus as soon as the crank (11) has reached its 360° degree of its track circle to stop the downward move of piston-chamber's (1) reciprocating motion before the latter's vertical side area that is hermetically adjusted to cylinder-chamber's interior vertical side reach the spot where the bottom side of conduits (19) are externally hermetically adjusted at the cylinder-chamber's trunk and before the conduits' (19) which work as a counter component to piston-chamber's (1) hydro-gravity force power equalize to a zeroed resultant of force,

Also at the end of the second period upward motion of piston-chamber (1) the later has to stop a little before the piston-chamber's hermetically plugged topside one line up with the surface level of hydro-container's (7) liquid staff, the conduits' (19) top side, and before the hydro-container liquid staff's gravity-hydro-static's force of action equalize with the incoming gravity's force and where all forces of action will come to a balancing zeroed resultant of force where about the tension of gravity-hydro-static force applied to piston-chamber (1) will continue to exist as the last has reached the T.D.C. (24) of its reciprocating motion,

Precisely as said piston-chamber's (1) reciprocating motion has reached the T.D.C. (24) and crank (11) its 360° track circle both disc-valves (2) and (17) close instantly within seconds of a minute and similarly close instantly as soon as piston-chamber (1) has reached the B.D.C. (25) if its reciprocating motion and crank (11) its 180° degree track circle,

The total interior area of said outlet conduits (19) no matter how many they are in number must be smaller than the interior area of said piston chamber (1) therefore the liquid's specific gravity compressive force of the liquids contained in said outlet conduits (19) must be permanently less than the specific gravity compressive force of the hermetically insulated liquid matter inside of said piston chamber (1), there fore the difference of the two compressive component forces applying compressing force at the same portion of liquids matter that is trapped within the cylinder-chamber's fluctuator displacer separator (15) interior area underneath the piston-chamber's (1) disc-valve (2) will make it possible for said piston-chamber (1) overwhelming force to force cylinder-chamber's (15) liquid matter to drain back to hydro-container (7) from the conduit's (19) top side (that equilibrate with hydro-container's (7) liquids level, the T.D.C. (24) of piston-chamber's (1) reciprocation motion) through said conduits (19) interior area, thus piston-chamber (1) is immersing within hydro-container's (7) liquid matter gravity-hydro-static's tension of squashing compression from cylinder-chamber's (15) interior area where at the same time create liquid matter vacuum area column within cylinder-chamber's (15) interior area above piston-chamber's (1) hermetically plugged top side (5),

The vessel crank-cam-shaft chamber's interior area must be totally watertight,

The liquid staff's quantity that is used as a working agent must be sufficient as to be capable to develop the indispensable proper sustained gravity-hydrostatic tension of squashing compression that will accordingly higher than the piston chamber's (1) dimensions and gravity resistance force,

Construction materials of piston-chamber-hydro-gravity engines must be of resistant ones to oxidation, preferably of stainless steel made,

The one top side of conduits (19) must be in the same level with the hydro-container liquids' matter level,

To achieve the best of piston-chamber's (1) hermetical reciprocation within the cylinder-chamber fluctuator displacer separator (15) Whenever necessary piston rings or rubber membranes could be an aid, so as to allow piston-chamber's (1) hermetical adjust the tolerance between piston vertical wall and cylinder vertical walls,

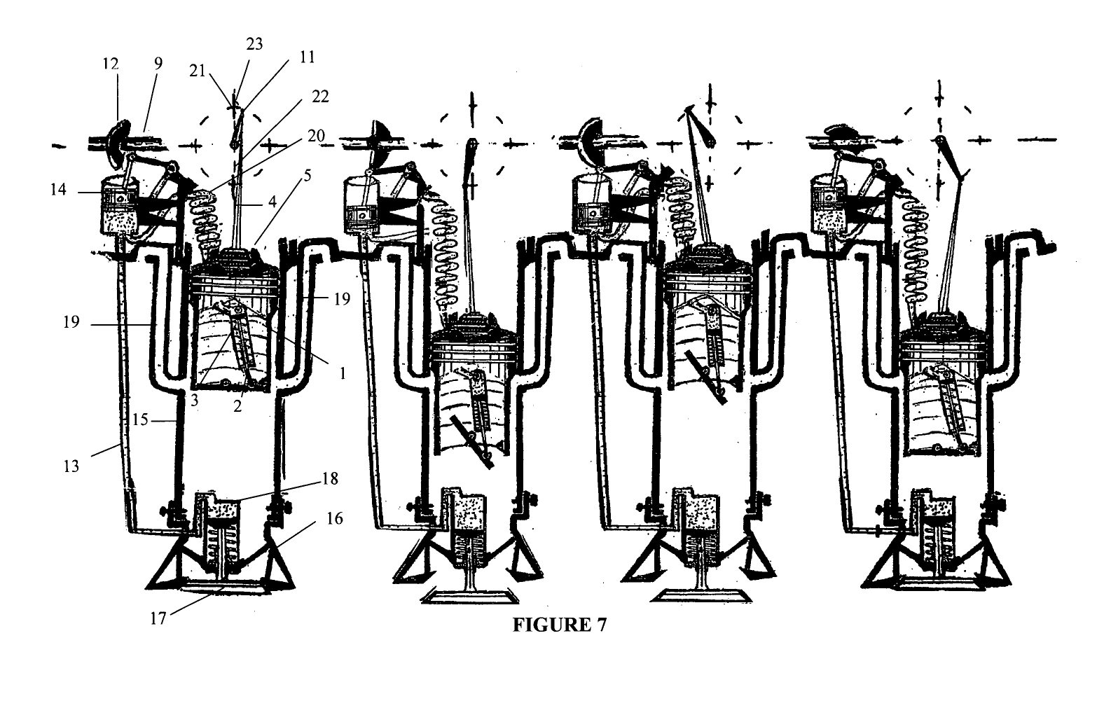

As FIG. 7 in a diagrammatic view exhibit an exemplary of a quadrupled cylinder piston-chamber hydro-gravity engine (that is belong to multi-cylinder piston-chamber hydro-gravity engine) that according to the method consisting its technological engineering composed of four cylinder-chambers fluctuators displacers separators (15), equal in number piston-chambers (1), articulated to equal in number cranks of a single crank-cam-shaft (11) by equal in number connecting rods (4) a single vessel crank-cam-shaft chamber and a single hydro-container (7) by exploiting the gravity-hydrostatic tension of squashing compression sustain within this very hydro-container (7),

From left to the right FIG. 7 in a diagrammatic view exhibits the first cylinder-chamber's (15) piston-chamber (1) been articulated by its connecting rod to the common crank-cam-shaft (9) first crank (11) where the latter is in the beginning of its 180° degree track circle where the piston-chamber (1) to have started immersing within the gravity-hydrostatic tension of squashing compression that exist within the hydro-container's (7) liquid matter through cylinder-chamber's interior area (15) and disc-valves (2) and (17) are closed where according to the present invented method consisting the technological engineering of piston-chamber hydro-gravity engine apply in working order the first period of its piston-chamber's reciprocating motion,

From left to the right FIG. 7 in a diagrammatic view exhibits the second cylinder-chamber's (15) piston-chamber (1) been articulated by its connecting rod to the common crank-cam-shaft (9) second crank (11) where the latter to have past its 180° in an upward motion toward its 360° degree track circle where the piston-chamber (1) to have started emerging from within the gravity-hydrostatic tension of squashing compression that exist within the hydro-container's (7) liquid matter through cylinder-chamber's interior area (15) and disc-valves (2) and (17) are open where according to the present invented method consisting the technological engineering of piston-chamber hydro-gravity engine apply in working order the first period of its piston-chamber's reciprocating motion,

From left to the right FIG. 7 in a diagrammatic view exhibits the third cylinder-chamber's (15) piston-chamber (1) been articulated by its connecting rod to the common crank-cam-shaft (9) third crank (11) where the last close approaching its 360° in an upward motion toward its 360° degree track circle where the piston-chamber (1) is close competed its upward of its reciprocating motion emerging from within the gravity-hydrostatic tension of squashing compression that exist within the hydro-container's (7) liquid matter through cylinder-chamber's interior area (15) and disc-valves (2) and (17) are still open where according to the present invented method consisting the technological engineering of piston-chamber hydro-gravity engine apply in working order the first period of its piston-chamber's reciprocating motion is close to complete it,

From left to the right FIG. 7 in a diagrammatic view exhibits the forth cylinder-chamber's (15) piston-chamber (1) been articulated by its connecting rod to the common crank-cam-shaft (9) forth crank (11) where the last is to end of its 180° degree track circle where the piston-chamber (1) to end its immersing within the gravity-hydrostatic tension of squashing compression that exist within the hydro-container's (7) liquid matter through cylinder-chamber's interior area (15) and disc-valves (2) and (17) are still closed where according to the present invented method consisting the technological engineering of piston-chamber hydro-gravity engine apply in working order the first period of its piston-chamber's reciprocating motion is close to complete it,

Thus the four piston-chambers' complete reciprocating motion in two periods turning a single crank-cam-shaft (9) to 360° degree is achieved by two pairs of piston-chambered cylinder-chambers fluctuators displacers separators (15), where the four piston-chambers (1) are articulated to a single crank-cam-shaft (9) of four cranks (11), four connecting rods (4) and four cams (12) these activate the four piston-pumps (14) these in turn activate the four valve-gears (3) and valve-gears (17) a single vessel crank-cam-shaft chamber (8) and a single hydro-container (7) where liquid matter that develop the gravity-hydrostatic tension of squashing compression sustains, capable to be exploited by the four piston-chambered cylinder-chambers (15),

As FIG. 7 in a diagrammatic view exhibit, the exemplary of a quadruple cylinder piston-chamber hydro-gravity engine that can be a multi-cylinder piston-chamber hydro-gravity engine. The principle of it is that the more piston-chambered cylinder-chambers (15) been used, the better the function of piston-chamber hydro-gravity engine is, because in this way the more said piston-chambered cylinder-chambers are, the better they can manage to create and sustain the liquids vacuum area within the gravity-hydrostatic tension of squashing compression perpetually and, therefore the created force of gravity-hydrostatic effort to fill the liquid's vacuum area remains no ceased in regular base and, therefore hydro-gravity's push working for and against gravity's keep piston-chambers (1) to reciprocate in and out of gravity-hydro static's tension of squashing compression from inside the cylinder-chamber (15) with no cease and, the crank-cam-shaft (9) converting said piston-chamber's (1) reciprocation to a crank-cam-shaft's axial rotation force of action remains no cease and capable to be used multi-purposely in safe environmental presuppositions, as there is no any production of harmful by products to pollute or contaminate the environment and its kinetic force production intensity can be measured from one kilogram to megatons force, that is proportionate to the size of the piston-chambered cylinder-chamber (15), the number of piston-chambers (1) and the quantity liquid matter's gravity-hydrostatic exploitation. More to it the multi piston-chambered cylinder-chamber's of piston-chamber hydro-gravity engine compared to single piston-chamber cylinder-chamber's, the first mentioned solve a difficulty that the second one face when the gravity-hydrostatic tension of squashing compression of hydro-container's liquid matter have to be used exclusively, as during the two periods of piston chamber's (1) reciprocation inside cylinder-chamber (15) the level of liquid matter inside hydro-container (7) fluctuate and cause problems of gravity-hydrostatic malfunction that affects the mechanical system,

The more piston-chambered cylinder-chambers (15) been used the more the function of piston-chamber hydro-gravity engine potential improve.

The number of piston-chambered cylinder-chambers of a piston chamber hydro-gravity engine can be increased as in pairs can be adjusted in working order together by interconnecting their two cranked-cam shafts with gear wheels

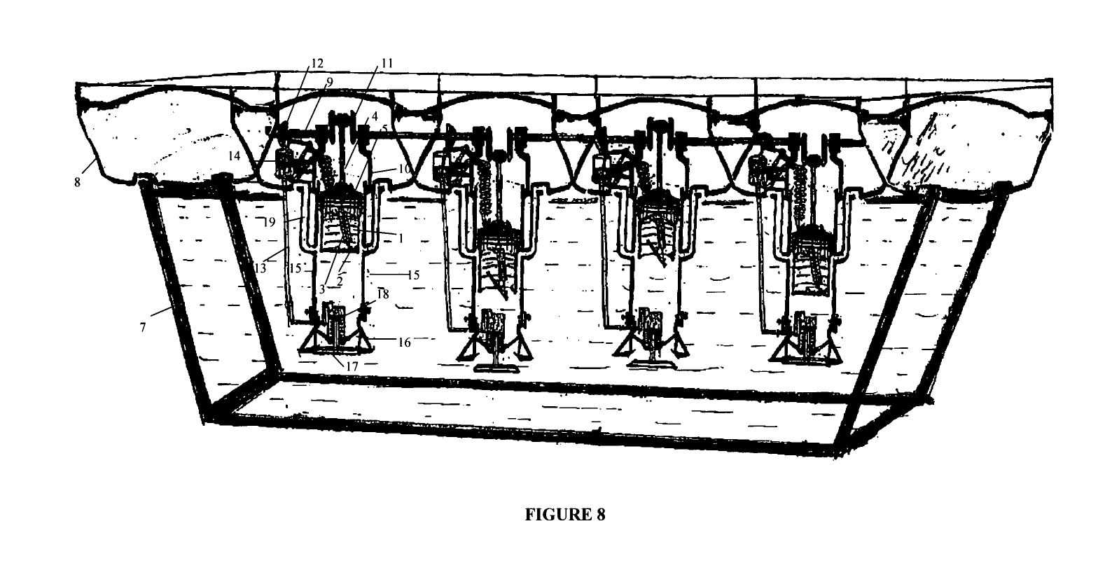

FIG. 8, is a diagrammatic view configuration exhibit an example of four similar piston-chamber hydro-gravity engines co-operating together with a common crank-shaft applying the method of the present invention exploiting the hydro-gravity's hydrostatic compression massive stagnant liquid matter contained exclusively within the hydro-container (7).

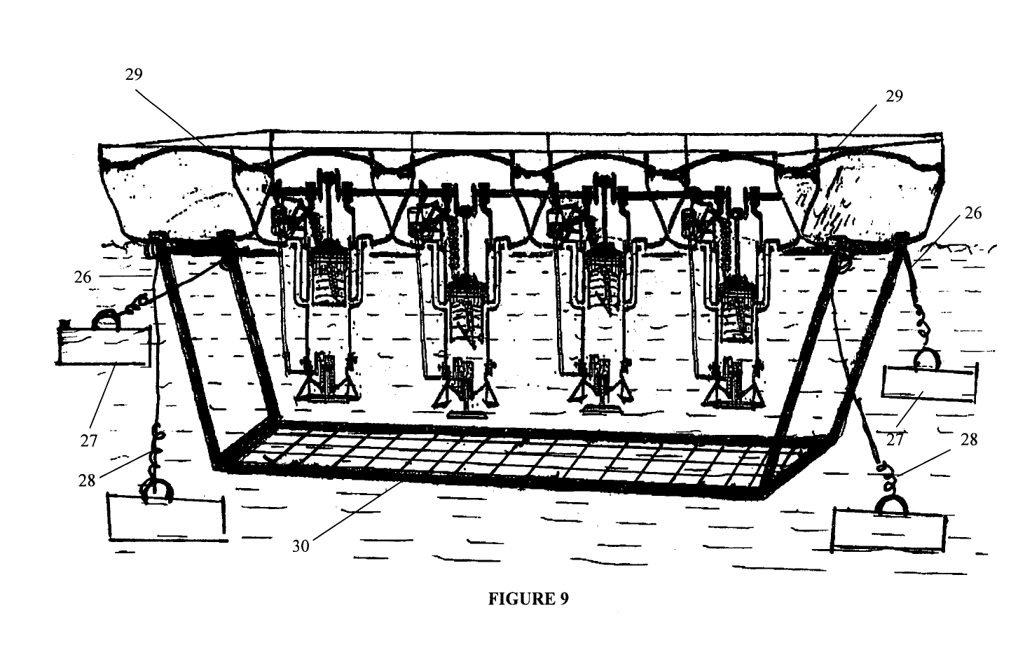

FIG. 9, is a diagrammatic view configuration exhibit an example of four piston-chambered (1) cylinder-chamber's (15) piston-chamber hydro-gravity engine co-operating together with a common crank-shaft applying the method of the present invention exploiting the hydro-gravity's hydrostatic compression of massive stagnant liquid matter of a natural basin such as, sea water, pond, lake etc where the hydro-container's (7) bottom side panel is been replaced by a grilled panel that is capable to prevent the entrance of unwanted materials or aquatic life within its interior area as now the hydro-container (7) serves as mean to stabilize the level of free waters in natural basins

According to method of technological engineering the piston-chamber hydro-gravity engine, the vessel crank-cam-shaft chamber (8) now serves as a crank-cam-shaft chamber and as a piston-chamber hydro-gravity engine's floating platform, where the frame and panels of the hydro-container (7) now is made in a manner to make it capable to balance its light displacement with the displacement tonnage of the free waters gravity-hydrostatic tension of squashing compression also

FIG. 9, is a diagrammatic view configuration exhibit an example of four piston-chambered (1) cylinder-chamber's (15) piston-chamber hydro-gravity engine exploiting the sea or lake stagnant water's gravity-hydro-static tension of squashing compression where its deep waters do not make it possible for piston-chamber-hydro-gravity engine to touch the depths, therefore security hawsers (27) chains or wire hawsers and hawser springs are used, joint to counterpoise weights, they are placed at the depths of deep waters securing the piston-chamber hydro-gravity engine.

The innovation of the present invention of the method consisting the technological engineering of piston-chamber hydro-gravity engine can be defined comparing it by taking as an example an embodiment of a combined electric motor with a piston-water-pump or piston hydro-motor with an electric motor or piston-hydraulic motors with a combustion piston motors or a piston-pump combined with a hydraulic piston motor.

As it is well known with piston motors of internal combustion, steam piston motors, or electric motors, animals or by hand, men can activate hydraulic-pumps, which in turn pump the stagnant water of a pond, sea, or lake and send it to somewhere else. With piston-chamber hydro-gravity engine is totally the opposite, more precisely, instead of having an electric motor applying force to a piston water pump and make its piston to reciprocate within a cylinder and pump the stagnant water to some where else, or differently, instead of having a piston hydro-motor exploiting the moving waters descending from high places to activate its piston, where the latter continuously turn a crank-shaft and, crank shaft turn the piston of a piston-pump to pump the stagnant water and send it to somewhere else, the piston-chamber hydro-gravity engine's present invented method consisting the technological engineering of piston-chamber hydro-gravity engine, make the forces of said Hydro-gravity's hydrostatic compression of massive stagnant waters to make it possible for said piston-chambers, to reciprocate within cylinder chambers as pistons of a water pump do and, instead of pumping the stagnant water, in vice versus mode, the inner tension of gravity hydrostatic squashing compression of stagnant water makes the piston-chambers to reciprocate and make crank shafts to turn and, in turns make an electric generator to generate hydro-electricity or provide any other form of work, which is something that experts in this field so far admit it is impossible to be occurred.

1. The method consisting the system produce mechanical kinetic force of work by exploiting gravity to convert gravity-hydro-static's stagnant tension of squashing compression sustain within the stagnant liquid matter that fill natural basins or artificially made containers and, converts it to an inexhaustible energy source of hydro-gravity moving force of action working alternative homo-acting and counterpoise-acting to gravity where at the same time exploit (said created) hydro-gravity's moving force of action by using it as a working agent of its function to produce the mechanical kinetic force of work in demand of multi-purpose use, characterized by,
a. A gravity driven mechanical system named piston-chamber hydro-gravity engine,
b. The capability of designing and assembling the particular accessories with their moving and no moving parts, assembled to a single mechanical system in reciprocal successive order of cooperative adjustment, capable to convert the stagnant gravity-hydrostatic tension of squashing compression sustain within the stagnant bulky quantity of liquid matter that fill the natural made basins such as sea, lake, pond or artificially made hydro-containers and hydro-reservoirs, to hydro-gravity's force of action working for or counterpoise to gravity's naturally orientated velocity direction and at the same time exploit it as a force-power working agent capable to produce mechanical kinetic work of multi-purpose use,
c. The method's capability consisting the technological engineering of the quadruple (piston-chambered cylinder-chamber) piston-chamber hydro-gravity engine.

2. The piston-chamber hydro-gravity engine of claim 2, constitute a single embodiment of assembled particular accessories together composed of moving and immobile parts working in reciprocal successive order of cooperating adjustment characterized by,
a. The hydro-container (7) that in particular occasions is totally sealed and in particular occasions semi-sealed, depended accessory of claim 2,
b. The cylinder-chamber (15) fluctuator displacer separator depended accessory of claim 2,
c. Valve-chamber (16), depended accessory of cylinder-chamber (15) of claim 2,
d. The disc-valve (17) depended accessory of valve-chamber (16) of claim 2,
e. The hydraulic gear (18) that activate the disc-valve (17) depended part of disc-valve (17) of valve-chamber (16) depended accessory of claim 2,
f. The conduits (19) part accessory of cylinder-chamber (15) depended accessory of claim 2,
g. The piston-chamber (1) moving particular accessory embodiment mechanism of cylinder-chamber (15) look like an upside down bucket where its top side is permanently hermetical plugged depended accessory of claim 2,
h. The base (5) particular accessory embodiment of piston-chamber (1) accessory of claim 2,
i. The pin-shaft (6) embodiment part of piston-chamber (1) accessory of claim 2,
j. The disc-valve (2) embodiment part of piston-chamber (1) accessory of claim 2,
k. The hydraulic gear (3) that activate the disc-valve (2) depended part of piston-chamber (1) depended accessory of claim 2,
l. The vessel crank-cam-shaft chamber (8) depended accessory of claim 2,
m. The portable cover (29) depended part of vessel crank-cam-shaft chamber (8) depended accessory of claim 2,
n. The crank-cam shaft base with its bearings (10) depended part of vessel crank-cam-shaft chamber (8) depended accessory of claim 2,
o. The crank-cam shaft (9) depended part of vessel crank-cam-shaft chamber (8) depended accessory of claim 2,
p. The hydraulic pump (14) depended part of vessel crank-cam-shaft chamber (8) depended accessory of claim 2,
q. The hydraulic pipes (13) and (20) that through them the hydraulic pump (14) activate the disc gears of disc-valves (3) and (18) embodiment parts of piston-pump (14) and gears (3) and (18) embodiment accessory of claim 2,
r. The connecting rod (4) depended part of piston-chamber (1) and the crank-cam shaft's (9) embodiment accessory of claim 2.

3. The method of claim 1 that determines the designation and arrangement of the particular accessories co-assembling to coefficient co-operational correspond embodiment of a single piston-chamber hydro-gravity engine characterized by,
a. The cylinder-chamber (15) with its moving and immobile coefficient embodiment accessories that is permanently submerged within the gravity-hydrostatic inwards and outwards tension of squashing compression sustained within the liquid matter particularly formed to suitable three dimensional shape fill the interior area of similarly formed three dimensional shape hydro-container (7) where is said cylinder-chamber is secured by supporting legs or side girders,
b. The piston-chamber (1) particular accessory, (with its moving and immobile coefficient embodiment accessories) adjusted inside said cylinder-chamber (15) articulated to crank (11) by its connecting rod (4) capable to hermetically reciprocate within the inside area of said piston-chamber (15) like pistons of piston motor do,
c. The said vessel-crank-cam shaft chamber (8) particular accessory embodiment (with its moving and immobile coefficient embodiment accessories where with its bottom exterior side is resting hermetically fixed on the topside of said hydro-container (7),) where at an opening of its bottom side of said vessel crank-cam-shaft-chamber the cylinder-chamber (15) with its top outer side of equal diameter dimensions been adjusted and hermetically fixed with the rest of its said cylinder-chamber's trunk extending vertically downward inside said hydro-container (7),
d. The said hydro-container (7) dependent accessory of claim 2, where its three dimensional shape likewise form the three dimension shape of the liquid stall fill the hydro-container's (7) interior area capable to serve as a depended working agent of piston-chamber hydro-gravity engine.

4. The arrangement of working provision order between the differences of the particular mechanical accessories ordinances assembled to an embodiment of a single mechanical system named piston-chamber hydro-gravity engine as thus has been arranged by the solicitude of claim 1 method (consisting the technological engineering of piston-chamber hydro-gravity engine) that makes the reciprocal successive of each particular accessory cooperating force of action order to be achieved.
a. The total interior area of said outlet conduits (19) no matter how many they are in number must be smaller than the interior area of said piston chamber (1), thus the hydro-gravity's force of action of the liquid's specific gravity contained in said piston-chamber (1), overwhelms the hydro-gravity's force of action of the liquid's specific gravity force contained in said conduits (19), that is permanently less than the specific gravity compressive force of the hermetically insulated liquid matter inside of said piston chamber (1), therefore the difference of the two hydro-gravity's component compressive forces applying compressing force at the third portion of liquids matter that is trapped within the cylinder-chamber's fluctuator displacer separator (15) interior area underneath the piston-chamber's (1) disc-valve (2), will make it possible for said piston-chamber's (1) overwhelmingly to force cylinder-chamber's (15) liquid matter to drain back to hydro-container (7) from the conduit's (19) top side that equilibrates with the hydro-container's (7) liquids level,
b. The length of the diameter of the track circle (21) of said crank (11) must be slightly smaller than the length of the distance of piston chamber's (1) reciprocating upward and downward of itch period motion inside cylinder-chamber fluctuator displacer separator (15),
c. The exterior walls of said piston chamber (1) or part of the vertical wall of said piston chamber (1) and, the interior vertical wall of said cylinder chamber fluctuator displacer separator (15) are finely turned and polished so as to allow said piston chamber (1) to reciprocate hermetically as the friction tolerance between the vertical exterior walls of said piston chamber (1) and the interior vertical wall of said cylinder chamber fluctuator displacer separator (15) is perfect and does not allow the water which is inside said cylinder chamber (15) underneath said disc valve (2) to leak through to the upper area of cylinder-chamber (15), that is above the top hermetical plugged side of said piston chamber (1) and, in the meanwhile allow said piston chamber's (1) to easy reciprocate hermetically (like pistons of piston motors reciprocate),
d. The area where the conduit's bottom side is adjusted and hermetically fixed at the cylinder-chamber (15) is under the area of the B.D.C. (25) that is the bottom dead centre where the first period of piston-chamber's (1) reciprocates motion ends, for the second period of piston-chamber's reciprocate motion to start inside the cylinder-chamber (15),
e. Said piston-chamber's (1) disc-valve (2) and valve-chamber's (16) disc-valve (17) both open instantly within seconds of a minute at the beginning of piston-chamber's (1) second period of its reciprocating motion, as it started its emersion from the gravity-hydro-static tension of squashing compression, from inside the cylinder-chamber's (15) interior area, as the crank (11) approximately is at its 180° degree track, the piston-chamber's (1) bottom vertical side that is hermetically adjusted at the cylinder's (15) vertical interior side reach its B.D.C. (25), where the conduit's (19) bottom side is adjusted hermetically fixed at the cylinder-chamber (15), or close instantly within seconds of a minute at the beginning of piston-chamber's (1) first period reciprocate motion as it started its immersion into the gravity-hydro-static tension of squashing compression inside the cylinder-chamber's (15) interior area, as the crank (11) approximately is at its 360° degree track, the piston-chamber's (1) top vertical side that is hermetically adjusted at the cylinder's (15) vertical interior side reach its T.D.C. (24), where the top side of piston-chamber (1) that is permanently hermetical plugged is approximately close to surface level of the liquid staff fill in the hydro-container (7) acting as a working agent of piston-chamber hydro-gravity engine,
f. The forming said hydro-container (7), where its three dimensional shape insulating panel frame, like wise form the three dimension shape of the liquid matter fill the hydro-container's (7) interior area used as a dependent working agent capable of converting hydro-gravity's force of action (composed by gravity's force and liquid) in to a gravity-hydro-static tension of squashing compression sufficiently suitable to demand, as to be used as working agent of the technological system piston-chamber hydro-gravity engine,
g. The forming of said three dimensional shape of the liquid matter fill the hydro-container's (7) interior area, where at times it serves as a working agent of the piston-chamber hydro-gravity engine exclusively, the said hydro-container (7) is totally insulated, or otherwise at times the working agent is been used is the gravity-hydrostatic tension of squashing compression exist within the liquid matter of natural basins, the hydro-container is to be used as water-controller of the inwards and outwards tension of the squashing compression of the liquid mater sustained in sea lake or ponds where the hydro-container is partly water-tide, as its bottom part is closed by a protecting net-grill that protects its interior area from entering unwanted objects or aquatic life,
h. The vessel crank-cam-shaft chamber (8) hermetical condition is necessary for the technological system piston-chamber hydro-gravity engine's function.

5. The course's serial steps of the successive mutual reciprocity cooperation by turns and mutual reciprocity function of the particular accessories composed by their embodied parts working as a single embodiment technological system composing the piston-chamber hydro-gravity engine of claim 2 as has being technologically engineered by the method of claim 1 characterized by,
a. The said hydro-container (7) whose walls convert the hydro-gravity's force of action induced by gravity's force of action, to a gravity-hydrostatic tension of squashing compression in demand, suitable to serve as a dependent working agent of piston-chamber hydro-gravity engine of claim 2, or where at times the working agent of piston-chamber hydro-gravity engine is being used is the gravity-hydrostatic tension of squashing compression exist within the liquid matter of natural basins such as sea, lake, ponds or artificially made reservoirs the hydro-container is to be used as a controller of the inwards and outwards tension of the gravity-hydrostatic squashing compression,
b. The cylinder-chamber (15) which is permanently submerged within the gravity-hydro-static squashing compression that exists and develops within the liquid matter that fills the interior area of Hydro-container (7), where the cylinder-chamber (15) permanently displaces a portion of it and compels the balanced gravity-hydro-static stagnant tension of squashing compression to apply force of action upon the outside walls of cylinder-chamber (15) fluctuator displacer separator, in proportion to its three dimensional volume whereby now the gravity-hydro-static tension of squashing compression of hydro-container (7) have developed into hydro-gravity tension that applies force to the exterior walls of cylinder-chamber (15).
c. The disc-valves (2) and (17)—when the piston-chamber (1) has reached its B.D.C. area of each reciprocating motion both open instantly and, convert the gravity-hydro-static tension of squashing compression to hydro-gravity force of action of hydro-gravity moving power of liquid matter, that is moving counter to gravity's direction and in this way counter gravity force is created that apply force of action through the open valves (17) and (2) underneath the permanently hermetically plugged top side of piston-chamber (1), proportional to the three dimensional interior area of cylinder-chamber (15), which is filled with air and situated above the plugged side of piston-chamber (1), through which the piston-chamber (1) moves back to the surface counter to gravity's direction until its plugged top side approximately levels with the level of liquid matter which fills the hydro-container (7) and, is being used as a working agent of piston-chamber hydro-gravity engine, where at this stage of its function the piston-chamber's second period of reciprocating motion has been accomplished, where during piston-chamber's (1) upward motion turns by each connecting rod (4) whose one side is articulated to pin shaft (6) and with each other is articulated to crank (11) turns the crank to 360° degrees of each track of motion, where in its turn the crank (11) turns the crank-cam-shaft (9) to 360° degrees, where in its turn the cam (12) turns and releases the piston pump (14), where during the piston chamber's (1) second period of piston-chamber's hydro-gravity engine the cam (2) was pressing the piston of the piston pump (14), to hold the disc-valves (2) and (17) both open, where with the release of the piston of piston-pump (14) the last ceased to apply a force of action to valve gears (3) and (18) and, the springs situated in them compels the disc-valves (2) and (17) both to close instantly within seconds of a minute where inevitably starts the first period of piston chamber's reciprocating motion within the cylinder-chamber (15) where,
d. The closure of disc-valve (17) separates the gravity-hydro-static tension of motionless squashing compression consists within the cylinder-chamber (15), the piston-chamber (1) and, conduits (19) from the gravity-hydro-static tension of the stagnant squashing compression exists with total mass volume of liquid matter fills hydro-container (7), compelling the hydro-gravity's force of action of liquid matter that fills the interior area of conduits (19), to apply homo direction of gravity force of action and gravity-hydro-static stagnant tension of squashing compression exists within the cylinder-chamber's (15) piston-chamber's (1) interior area,
e. The closure of disc-valve (2) separates and hermetically seals the gravity-hydro-static tension of motionless squashing compression and hermetically insulates it within the interior area of piston-chamber (1), where is converted into a hydro-gravity force of action equal to specific gravity force of liquid matter that applies force of action upon the liquid matter that is confined within the interior cylinder-chamber's (15) area underneath the piston-chamber's (1) disc-valve (2), where likewise as gravity applies force upon the liquid matter that fills the interior area of conduits (19) converts it to hydro-gravity force of action which in turn applies force of action upon gravity-hydro-static tension, exists within the liquid matter there is underneath the disc-valve (2) and, thus we have two counter forces of action applying force a third one. The first is the hydro-gravity force of action of piston-chamber (1), the second one is the gravity's applied force of action upon the liquid matter exists within the conduits (19) and converts it into hydro-gravity force of action, which in turn applies force of action upon the third one of stagnant gravity-hydro-static force of action, where as the method of claim 1 adjusts the balance of these three counter acting forces, which are, the hydro-gravity force of piston-chamber (1) falling downwards within the cylinder chamber (15), working as hydro-gravity specific force that overwhelms the forces of action of conduits (19) hydro-gravity and, cylinder-chamber's (15) gravity-hydro-static stagnant squashing compression underneath disc-valve (2), where compel the latter to retreat and flow back to hydro-container (7) from the top side of conduit's (19) (that is at the same level of liquid matter that fills the hydro-container's interior area) through conduit's (19) interior area, where at the same time the piston-chamber (1) is immerging within the gravity-hydro-static tension of squashing compression that fill the interior area of hydro container (7) through the cylinder-chamber (15), pulling by each connecting rod (4) the crank (11) to its 180° degrees track circle, where at this stage the method of claim 1 resolves the crank (11) to hold the immersion of piston-chamber (1), where at the same time in its turn the crank (11) turns the crank-cam shaft (9) to its 180° degrees revolution, where the latter turns the cam (12), that in turn presses the piston of piston-pump (14), that in turn through the pipes (13) and (20) pumps air or liquids that compel the gears (3) and (18) to activate the disc-valve (2) and (17) to open instantly within seconds of a minute, where as a result of this the liquid matter of hydro-container (7) combines with the liquid matter of piston-chamber (2) and cylinder chamber (15) to an embodied force that counteracts to the gravity's course, where as one united hydro-gravity force of action applies force of action counteracting to gravity upon the interior of piston-chamber's (1) hermetically plugged side to repeat the second period of piston-chamber's (1) reciprocating motion inside cylinder chamber (15),

6. The technological system of quad tripled piston chamber cylinder chambered hydro-gravity engine of claim 2 that belongs to multi-piston chamber hydro-gravity engine as it has being technologically engineered by the present method of claim 1 characterized by,
a. Converts the gravity-hydro-static's stagnant tension of squashing compression into continuous forces of action, homo acting and counter acting to gravity, where the first hydro-gravity force of action as it creates the hydro-vacuum area within the interior area of cylinder chamber (15) above the permanently hermetically plugged side of piston-chamber (1) and, the second hydro-gravity force of action that works counter to gravity's course attempting to fill in the liquid's vacuumed area created within cylinder chamber's (15) which is above the permanently hermetically plugged top side of piston-chamber (1), which due to technological engineering of the system of multi-piston-chamber hydro-gravity engine function this said hydro-vacuumed alternatively remains empty where as a result, the piston-chambers pushed by homo-acting and counter-acting to gravity hydro-gravity forces of action reciprocate perpetually by using a common vessel crank-cam-shaft chamber (8), common crank-cam-shaft (9), common hydro-container (7), or use many crank-cam-shafts joined together by gear wheels synchronized, where in this way the creation of hydro-vacuum area perpetually created and sustained within the gravity hydro-static's tension of squashing compression is achieved, due to synchronized successive function of piston-chambers within the cylinder chambers where,
b. The first piston-chamber (1) is at the beginning of its first period of its reciprocating motion within the gravity-hydro-static squashing compression exists within the hydro-container (7), from inside the interior area of the first cylinder-chamber (15), the second piston-chamber (1) is at the start of its second period of the reciprocating motion within the gravity-hydro-static squashing compression exists within the hydro-container (7), from inside the interior area of the second cylinder-chamber (15), the third piston-chamber (1) is at the end of its second period of reciprocating motion within the gravity-hydro-static squashing compression exists within the hydro-container (7), from inside the interior area of the third cylinder-chamber (15), the fourth piston-chamber (1) is at the end of its first period of the reciprocating motion within the gravity-hydro-static squashing compression exists within the hydro-container (7), from inside the interior area of the second cylinder-chamber (15), where the synchronization of quad tripled piston-chambered cylinder-chamber hydro-gravity engine timing is 1-3-2-4. The synchronization of all quad tripled piston-chambered cylinder-chamber hydro-gravity engine which belongs to multi-piston-chambered-cylinder-chamber-hydro-gravity engine could be different, due to synchronization of said multi-piston-cylinder chambered-hydro-gravity engine, is created perpetually hydro-vacuum area within the gravity-hydro-static-tension of squashing compression and in this way perpetually the hydro-gravity pushes the cylinder-chambers to their reciprocating motion from within the cylinder chamber perpetually.
